(19) United States
(12) Patent Application Publication
(10) Pub. No.: US 2003/0083932 A1
(43) Pub. Date: May 1, 2003

(54) Advertising Method and System

(75) Inventors: Mr. Larry Wolf, Oxnard, CA (US); Mr. Todd White, Ventura, CA (US)

Correspondence Address: Larry B. Donovan, Arter & Hadden LLP, 1100 Huntington Building, 925 Euclid Avenue, Cleveland, OH, 44115-1475, US, larry.donovan@arterhadden.com, 216-696-3864, 216-696-2645

(73) Assignee: AdChek, Inc., Ventura, 93003 (US)

(21) Appl. No.: 09/781,788

(22) Filed: Feb. 12, 2001

Related U.S. Application Data
(60) Provisional application No. 60/181,611, filed on Feb. 10, 2000.

(51) Int. Cl. G06F 17/60; G09F 1/00

(52) U.S. Cl. 705/14; 705/35; 705/39

(57) ABSTRACT

### Abstract of Disclosure

The invention involves a novel method of advertising wherein advertisers are able to target market to employees through the placement of advertisements on employee pay stubs. The method involves the collection of information about advertisements from advertisers and employees and then matching employee information to the desired target audience of advertisements.

### Cross Reference to Related Applications

The present application claims the benefit of U.S. Provisional Application No. 60/181,611 filed February 10, 2000.

### Background of Invention

Consumer purchasing within the United States alone extends into the trillions of dollars annually, while advertisers expend billions of dollars annually in an effort to reach consumers. Advertising expenditure generally has two purposes: first to educate the public on benefits of a given product or service, and second to develop name recognition (branding). The theory behind increased name recognition is that a higher level of name exposure tends to create a sense of security on the part of the consumer and a recollection of a particular brand during a purchasing decision.

Numerous factors such as color selection, sounds, print styles, subject content, and shapes can be selected to develop a more predictable response with respect to a statistical base of potential consumers. Even time of day can be a significant factor in optimizing mental and emotional receptivity with respect to certain products and services. Frequency is clearly an important factor in achieving advertising success. "Marketing Guru" Jay Conrad Levinson, author of Guerrilla Marketing says a consumer has to be exposed to an ad 27 times before it has the desired effect. Frequency aside, one of the most important factors in the success of an advertisement is the state of mind of the consumer at the time of exposure to the ad. For this reason, point of purchase advertising is popular because it catches a consumer when they are in the very act of purchasing a product or service.

In U.S. Pat. No. 5,992,888, titled Advertising Device and Method for Use at Point of Sale, a transaction recording card for recording credit and debit purchases is disclosed. Third party advertising is placed on the card in a format that may be viewed by the purchaser at the time of making and recording a transaction. The device comprises a transaction ledger on an obverse side and an advertising space on a reverse side. Therefore, if a consumer chooses to use the recording ledger for recording debit and credit card purchases, the invention provides a method of achieving frequent point of purchase advertising.

Point of purchase advertising often reaches consumers after a decision to make a purchase has been made. For this reason, "point of action" advertising, wherein advertisers and direct marketers are able to reach consumers at or near the time when a consumer is close to making a purchase decision, is more effective than point of purchase advertising. However, point of action advertising is difficult to achieve because it requires that advertisers predict when consumers will be ready to make a purchase. It is therefore desirable to develop a system whereby consumers are exposed to repeated and frequent point of action advertisements. Numerous innovations for such advertising have been provided in the prior art that are described as follows. Although these innovations may be suitable for the specific individual purposes that they address, they differ from the present invention as hereinafter contrasted.

In U.S. Pat. No. 4,722,554, titled Alternative-Value Paper Refund Form, a form having obverse and reverse sides is disclosed. The obverse side comprises a negotiable instrument and an optional advertisement, while the reverse side comprises coupons or other alternative value incentives. The form is arranged so that the coupons on the reverse side partially overlap the negotiable instrument on the obverse side. Therefore, if a holder removes the negotiable instrument, the alternative coupons or value incentive is destroyed. The patented invention is designed to provide consumers with a choice: consumers can either cash the check or use the coupon, but they cannot do both. This type of design is particularly useful for bulk mailing contest entry forms containing small checks and coupons as incentives to enter a contest.

In U.S. Pat. No. 5,823,575, titled Advertising Check, a check having advertising information printed thereon is provided. The patented invention discloses a picture or design on a negotiable personal or company bank check. It further discloses a photograph or image in the background of a check for the purpose of advertising and promoting a particular product. The patented invention does potentially expose consumers to point of action advertising. However, the consumer's exposure to advertising on the check is limited in that the payee will likely deposit the check with the advertisement soon after receipt.

In French patent FR 2612325 A, titled Advertising Message Medium, and Method for Making Use of the Said Support, a combined check and advertising medium is disclosed. The check consists of a normal bank check which is extended by an additional panel upon which is printed advertising material from either the bank, the account holder, or a third party. In addition, the advertising panel may have perforations so that it can be detached from the check. Like U.S. Pat. No. 5,823,575, the patented invention provides a method for exposing consumers to point of action advertising, as they are more likely to make purchases soon after receiving a check. Furthermore, the patented invention is an improvement on the named U.S. patent because it provides the holder of the check with the option of removing the advertisement prior to depositing the check. However, the patented invention provides the holder with no incentive to retain the advertisement. Consequently, a consumer is likely to tear off the advertisement and immediately discard it. It is therefore desirable to achieve frequent and repeated point of action advertising wherein a consumer has an incentive to retain the advertisement.

Advertisers generally target consumers most likely to purchase a given product or service. Because one needs money to purchase a product, most of the target audience for any given product comprises consumers with paying jobs. However, there is currently no method by which advertisers can reach the over 135 million working Americans who receive either paychecks or direct deposit stubs other than through the purchase of demographic information from employers, credit card companies, and the like. Furthermore, companies spend billions of dollars in paper costs to purchase 5.85 billion payroll checks annually. It is therefore desirable to decrease the cost of payroll checks while providing advertisers with a medium for targeting consumers with paying jobs.

### Summary of Invention

It is therefore an object of the present invention to expand point of action advertising for advertisers and direct marketers.

It is a further object of the present invention to provide a novel advertising medium for point of action advertising.

It is an additional object of the present invention to provide consumers with point of action advertising that will not be immediately discarded.

It is yet another object of the present invention to provide targeted advertising to a preselected market segment of consumers who receive paychecks from their place of employment.

It is an additional object of the present invention to provide businesses with incentive to supply employee demographic information by reducing the cost of producing payroll checks. These and other objects are realized in a method for displaying advertisements on an employee's paycheck stub, comprising the steps of: receiving employee data respectfully associated with a plurality of employees; analyzing the employee data to categorize employees into a plurality of categories; receiving from advertisers advertisement data respectfully associated with a plurality of advertisements; associating advertisement data with a group of employees based on analysis of the employee data and the advertisement data; selecting an advertisement associated with a group of employees; and printing the selected advertisement on pay stubs of the group of employees.

A further process for coordinating the display of advertisements to targeted groups of employees, comprising the steps of: receiving employee data respectfully associated with employees of an employer; receiving advertisement data respectfully associated with advertisements of advertisers; choosing a set of employees from the received employee data; matching the advertisement data with the employee data to create a set of matching advertisements for the chosen set of employees; generating a list of advertisers associated with the matching advertisements; notifying the employer of the chosen set of employees that matching advertisers have been located; providing to the employer of the chosen set of employees the list of advertisers associated with the matching advertisements for the employer's approval; receiving from employer a list of approved advertisers associated with the matching advertisements; notifying the approved advertisers that target advertising is available for the chosen set of employees; accepting bids from the approved advertisers for the right to display to the chosen set of employees the matching advertisements with which they are associated; awarding to an approved advertiser the right to advertise to the chosen set of employees; receiving from the awarded advertiser a matching advertisement; submitting the received matching advertisement to the employer for approval; and running the advertisement upon employer approval.

### Brief Description of Drawings

Fig. 1A is an obverse view of an embodiment of a check used as an advertising medium in the present invention;

Fig. 1B is an reverse view of an embodiment of a check used as an advertising medium in the present invention;

Fig. 2A is an obverse view of a single perforation laser sheet embodiment of a check used as an advertising medium in the present invention;

Fig. 2B is an reverse view of a single perforation laser sheet embodiment of a check used as an advertising medium in the present invention;

Fig. 3A is an obverse view of a double perforation laser sheet embodiment of a check used as an advertising medium in the present invention;

Fig. 3B is an reverse view of a double perforation laser sheet embodiment of a check used as an advertising medium in the present invention;

Fig. 4A is an obverse view of an alternate double perforation laser sheet embodiment of a check used as an advertising medium in the present invention;

Fig. 4B is an reverse view of an alternate double perforation laser sheet embodiment of a check used as an advertising medium in the present invention;

Fig. 5A is an obverse view of a C-fold pressure seal style embodiment of a check used as an advertising medium in the present invention;

Fig. 5B is an reverse view of a C-fold pressure seal style embodiment of a check used as an advertising medium in the present invention;

Fig. 6A is an obverse view of a Z-fold pressure seal style embodiment of a check used as an advertising medium in the present invention;

Fig. 6B is an reverse view of a Z-fold pressure seal style embodiment of a check used as an advertising medium in the present invention;

Fig. 7 is a flow chart representing an embodiment of the present invention methodology;

Fig. 8 is a flow chart representing an embodiment of the present invention structure; and

Fig. 9 is a flow chart representing the hardware on an embodiment of the present invention.

### Detailed Description

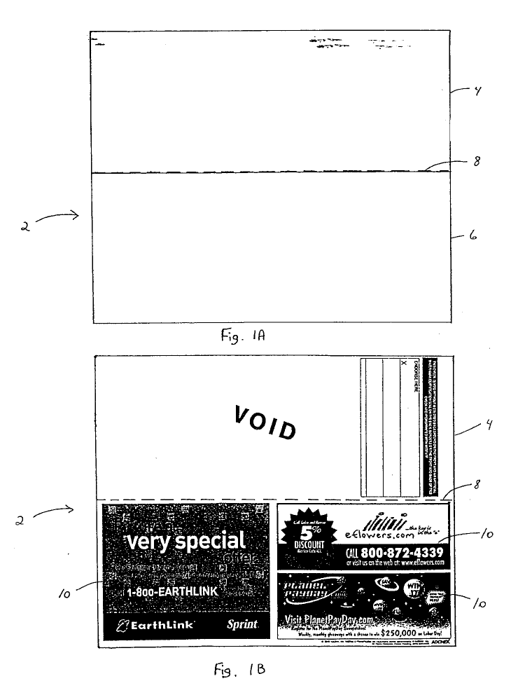

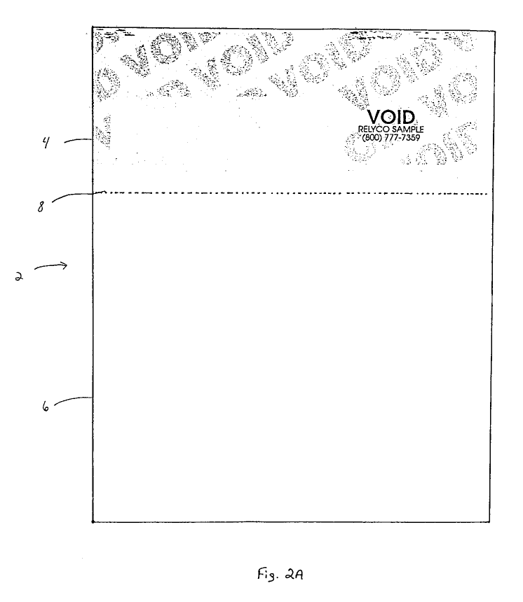

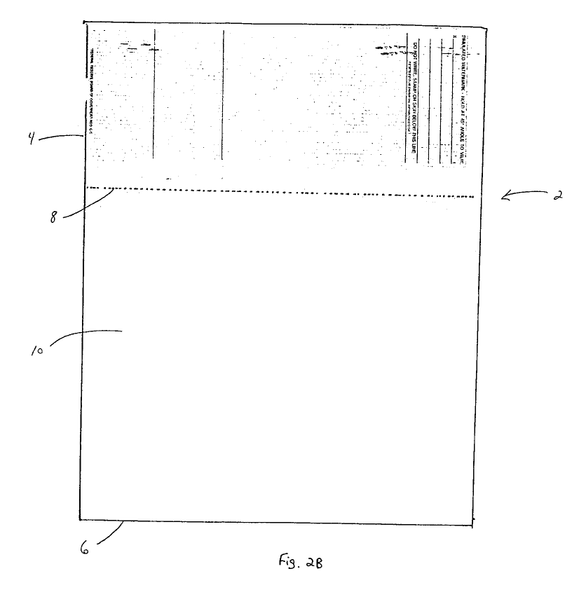

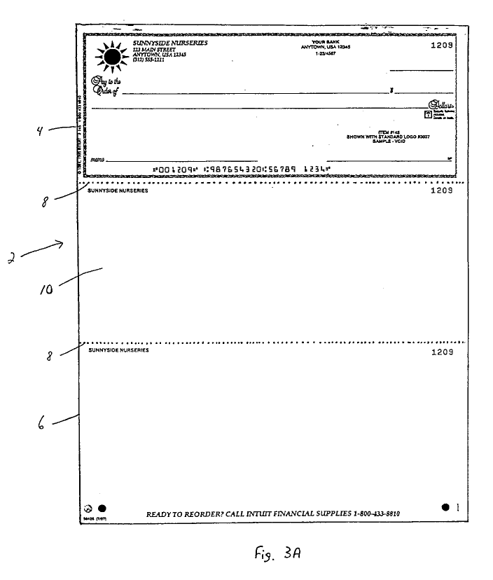

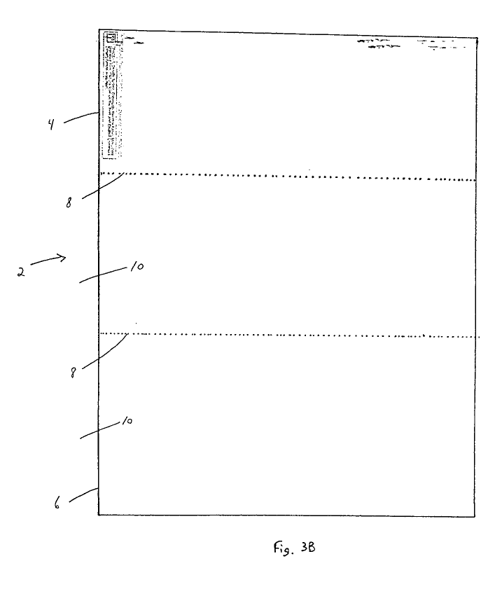

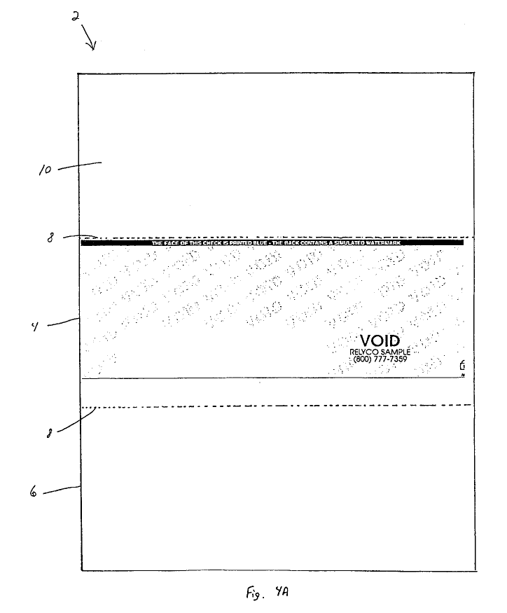

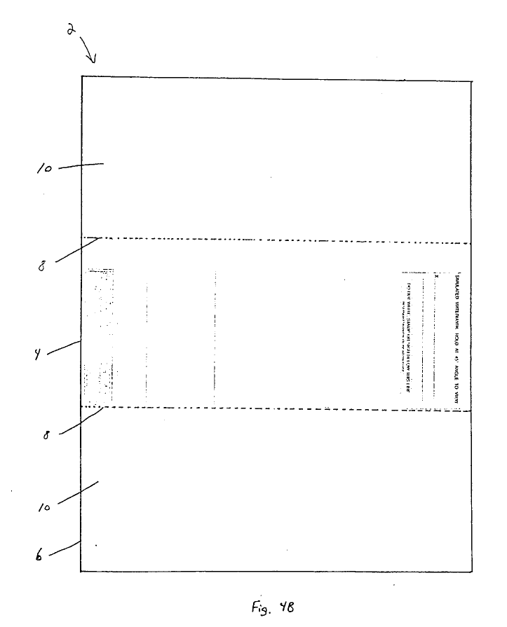

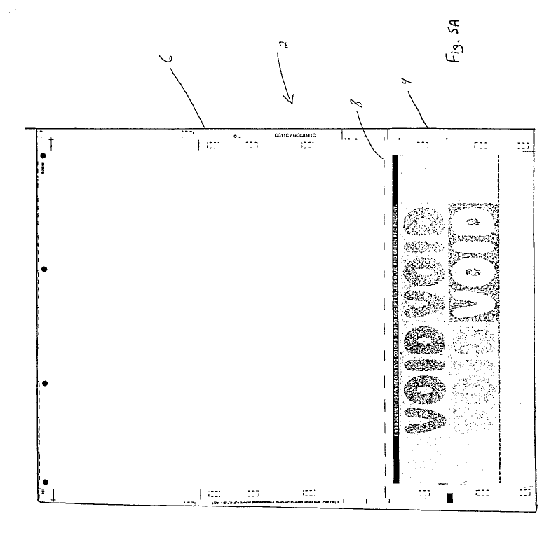

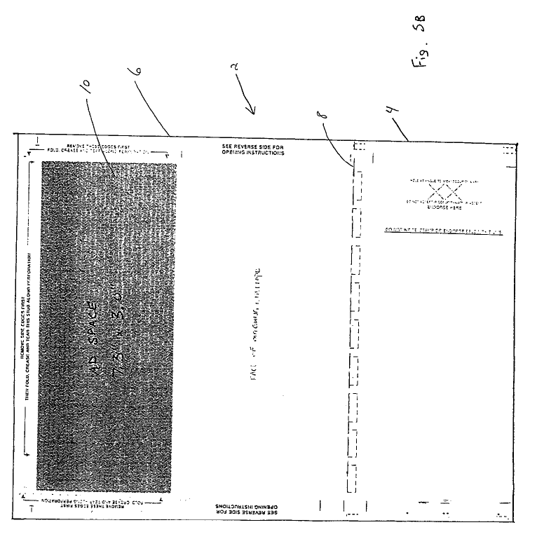

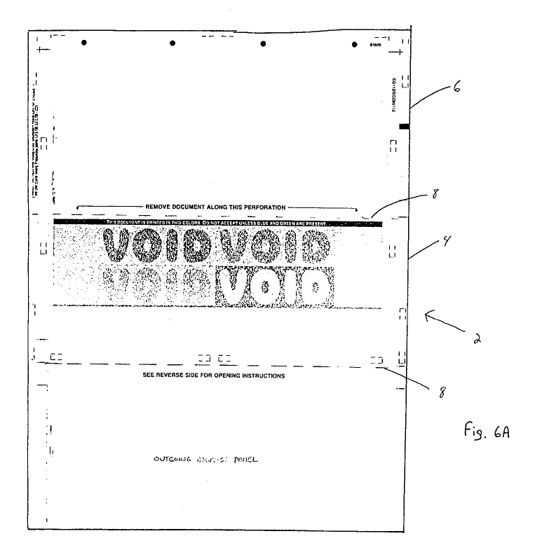

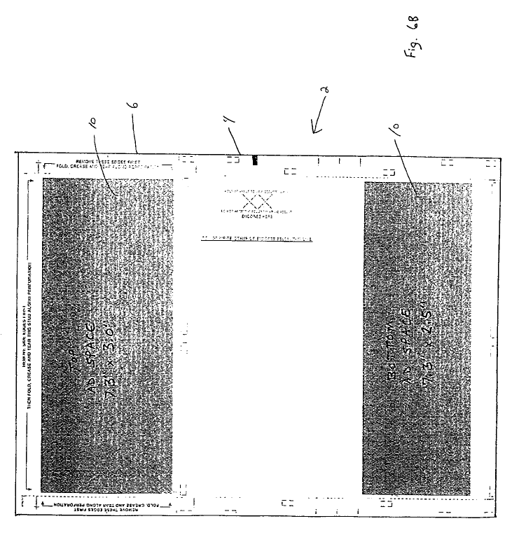

Referring now to the drawings, Figs. 1A - 6A show obverse views and Figs. 1B - 6B show reverse views respectively for various embodiments of checks 2 used as an advertising medium according to the present invention. Each embodiment provides a negotiable instrument 4 removably attached to a pay stub 6. The checks 2 may be in the form of a paycheck or a direct deposit pay stub. If the check 2 is a direct deposit pay stub, the negotiable instrument 4 will be void. Because pay stubs 6 are important financial records, it is desirable to be able to separate the negotiable instrument 4 from the pay stub 6. To accomplish this, most paychecks comprise perforation 8 to assist in the separation of pay stub 6 from negotiable instrument 4. As financial records, pay stubs 6 are not likely to be discarded when an employee receives a paycheck 2. For this and other reasons, employee pay stubs 6 are a particularly effective medium for advertising.

It is generally recognized in the advertising industry that one of the most difficult challenges that advertisers face is the task of reaching potential customers at an effective time, or when the customer is the right state of mind. The ultimate goal is to specifically customize advertisements so that all potential consumers are exposed to a given advertisement at a time when they are making an independent determination of whether or not they wish to purchase the product being advertised. There is no known method by which this task may be accomplished. In fact, when advertisers develop a focused and preselected customer base, it generally requires a large expenditure of funds.

The present invention provides a unique and inexpensive method of selective advertising focused to a particular marketplace; point of action exposure to customers; repetition of advertisements due to the extended life span of a check stub over the check itself; and a medium through which advertisers and direct marketers can achieve advertising that is close to a consumer's point of action because consumers often make purchasing decisions shortly after getting paid. Accordingly, the present invention involves the display of preselected advertisements and other materials on the reverse side of an employee pay stub. Advertising on the back of employee pay stubs influences employee spending habits because advertisements are seen frequently, consumers are very attentive to the advertising medium, and the advertisements are near the point of action when the consumer has "money in hand."

The configuration of the advertisements may vary in size, shape, color, etc. With the observation that all advertisements are theoretically more effective if delivered along with a paycheck, along with the understanding that targeted marketing techniques are considered more effective than randomized marketing techniques, combined with the fact that advertisements are proven to be more effective in repetition, it should be understood that many variables exist for content and configuration of the advertising materials.

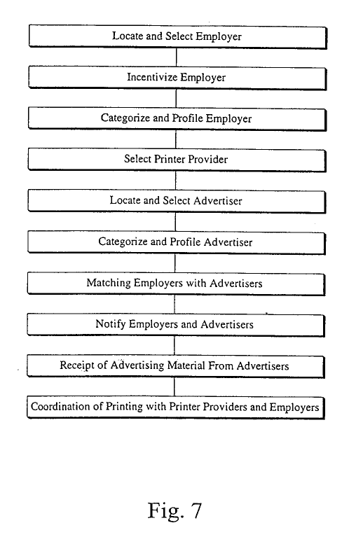

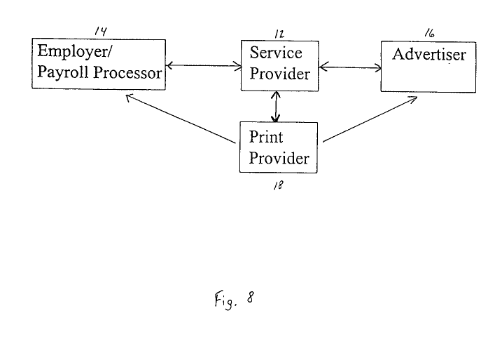

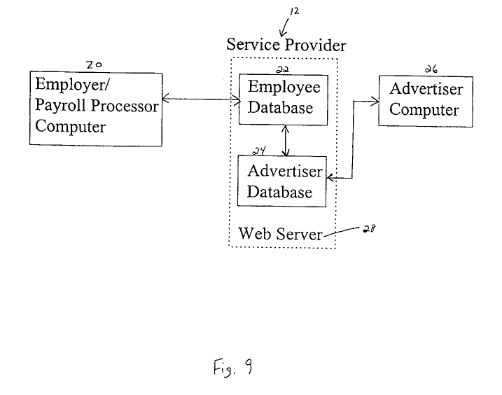

Many procedures can be used to effectively implement and develop the subject advertising methodology. In one embodiment represented as flow charts in Figs. 7 - 9, the process begins with a Service Provider's 12 selection of a target employer 14. It should be understood that the process represented in Fig. 7 may be performed in various sequences, and that Fig. 7 is merely representative of one common methodology. The selection of employers 14 may be based on a multitude of factors, including any combination of, but not limited to: size of employer, location, employee base, industry served, or brand name. Furthermore, an employer 14 may be targeted due to a specific request by a particular advertiser 16, as a result of suggestions from print providers 18 or partners, or from attention received by means of the employer's participation in a trade show. In addition, if an advertiser 16 who purchases advertisements according to the present methodology also utilizes the same advertising checks in its own company, it could be targeted both as an existing advertiser 16 and as an employer 14.

Once an employer 14 is targeted, the Service Provider 12 creates for the employer 14 an incentive for allowing advertising on its business forms. One such method of providing employers 14 with incentives is to offer the employer 14 a reduction in cost of business forms (e.g. payroll checks, direct deposit stubs, etc.). This is a reduction of cost directly from the print provider 18 for existing services and business forms already being purchased by the employer 14. This reduction can be as little as 5% or it could entirely eliminate the cost of the business form. Most employers 14 pay around $0.02 per check to a print provider 18. According to the present invention, advertising revenue may generate as much as $0.03 per check for the Service Provider 12. In this case, the Service Provider 12 would reduce the cost of the checks being sold to employers 14 by $0.02 per check, and make a profit while providing absolutely free business forms to the employer 14 through a print provider 18. The amount of revenue used to reduce the cost of checks is determined by the amount of revenue generated by the sale of the advertisements to advertisers 16 and direct marketers.

Another method by which a Service Provider 12 can incentivize employers 14 is to provide employers 14 with a rebate directly from the Service Provider 12. Generally, the Service Provider 12 prefers that employers 14 switch to a print provider 18 that is approved by the Service Provider 12. However, the Service Provider 12 may allow an employer 14 to continue to use its print provider 18, even though the print provider 18 is not a preferred provider of advertisement checks. In these cases, the Service Provider 12 can provide the employer 14 with a rebate directly from the Service Provider 12. It amounts to a payment made by the Service Provider 12 directly to the employer 14 in consideration for the employer's 14 continued use of the Service Provider's 12 advertising checks. The Service Provider 12 works with the non-preferred print provider 18 to ensure that all forms are printed correctly. Because the savings is passed from the Service Provider 12 to the employer 14, the payment relationship between the print provider 18 and the employer 14 does not change.

Another incentive method involves the issuance of a rebate from a preferred print provider 18 to the employer 14. In this case, print providers 18 pass along a savings to employers 14. Generally, the savings will take the form of a discount in print provider 18 billing to employer 14, a rebate or payout representing an accumulation of rebates for the use of advertising forms. These rebates are generally paid monthly or quarterly, although any rebate payment system involving accumulated rebates is contemplated by the present invention.

On occasion, it is not only important to provide an employer 14 with incentive to use advertising forms, but it is also important to provide an employer 14 with incentive to migrate to a standard form that is less costly, more efficient, or more conducive to advertising. For example, employers 14 using a pin feed or continuous feed form measuring 8.5"x 7.25" may be asked to migrate to an 8.5" x 11" laser cut form because the 8.5"x 7.25" form has less space available for advertising than does a 8.5"x 11" laser cut form because the 8.5"x 11" laser cut form can hold multiple advertising panels. Due in part to the available advertising space on the 8.5"x 11" form, it is much less expensive to produce than the 8.5"x 7.25" form. In order to assist the employer 14 in an effort to migrate to the preferred form, the Service Provider 12 may give the employer 14 credits toward the purchase of high speed laser printers, equipment or software for use in reconfiguring their systems.

In order for an employer 14 to participate in the program, the Service Provider 12 must collect from the employer 14 information that will enable the Service Provider 12 to categorize the employer 14. Table 1 shows a non-exhaustive sample list of collected employer 14 information. Referring to Table 1, the employee demographic information may include: age, gender, salary, psychographic and geographic information. The geographic information may or may not include the employee name and address. In order to provide employers 14 with a high level of protection for their consumer employees, it is possible to exclude employee name and street address information from the data collection. The remaining demographic information may be considered non-invasive marketing information, as it ensures that individual privacy is protected and that individual consumers remain anonymous. In addition, the employer 14 may also provide information relating to its locations of operation. This information may comprise office, business, plant and any other operation locations.

Table 1: Information Collected from Employers

| | |
|---|---|
| Type | Information |
| Employer/Employee | Employee demographics |
| | Operation locations |
| | Number of employees |
| | Number of W2's issued the previous year |
| Checks/Business Forms | Existing check information |
| | Number of checks produced annually |
| Industry | Distribution method and channel of product |
| | Industries served |
| Advertising | Suggested Advertisers to Target |
| | Suggested Advertisers to Avoid |

The Service Provider 12 also collects from the employer 14 information relating the employer's 14 checks and business forms. Included in this information is the number of checks that the employer 14 produces annually, which includes the number of pay periods per year. The Service Provider 12 further gathers information regarding the nature of the employer's 14 existing relationship with print providers 18, the current format of the checks it produces, and the employer's 14 current supply of checks.

Information regarding the employer's 14 industry is collected as well. This industry information comprises the employer's 14 distribution method, channel of product, and industries served. Advertising information is also collected from the employer 14 in order to facilitate an advertiser 16/employer 14 matching process. In collecting such information from an employer 14, the Service Provider 12 requests from the employer 14 a list of suggested advertisers 16 that the employer 14 feels may be a good match for its employee base. In addition, the Service Provider 12 requests a list of advertisers 16 that the employer 14 wishes to avoid. Oftentimes, employers 14 wish to prevent certain types of businesses from advertising on their business forms. Because the employer 14/advertiser 16 matching process requires approval by both the employers 14 and advertisers 16, it is helpful to know up front which types of advertisers 16 or specific advertisers 16 the employer 14 wishes to avoid.

The information collected from employers 14 is loaded into at least one employee database 22 managed by the Service Provider 12. The employee database 22 is capable of creating scenarios and employee profiles, based upon filtering criteria. For example, the Service Provider 12 may analyze and separate employees by client, zip code or by Designated Market Areas as compiled by Nielson Media Research. The employee database 22 allows the Service Provider 12 to then match information from employers 14 with an advertiser's 16 specific needs. In one embodiment where employee personal information remains confidential, neither the Service Provider 12, nor advertisers 16 are able to access an individual's name, phone number, or address. The Service Provider 12, with the consent of the employer 14, may also conduct randomized market research by placing calls to employees. This research may be conducted by the Service Provider 12, or by a research firm at the request of the Service Provider 12. Any additional information gathered by such research would be shared with the employers 14. The cost to perform such research may or may not be shared with employers 14.

The Service Provider's 12 employee database 22 containing employer 14 information is updated based on the nature of individual employers 14. The employee database 22 may be of any type, such as Microsoft Access or SQL Server. Preferably, the employee database 22 is linked to a web server 28. For employers 14 with more static employee information, the employee database 22 may be updated annually. For other employers 14, the employee database 22 information may be updated every 6 months, 3 months, every month, every pay period, or even every time a change is made internally to an employer 14 database. The process of updating the employer 14 information may comprise sending an electronic file such as a spreadsheet to the Service Provider 12 via e-mail. In another embodiment, the employer 14 may access a Service Provider employee database 22 linked to a web server 28 where the employer 14 can update its information. In this embodiment, the employer 14 can use any employer computer 20 to access a secure web server 28 having data managed by the Service Provider 12. In yet another embodiment, the employer's 14 internal database may be configured to interact with the Service Provider's employee database 22 so that any change to the employer's 14 internal employee and payroll databases dynamically updates the Service Provider's employee database 22 . This configuration can be accomplished through use of a software program designed by the Service Provider 12 to automatically categorize employee information and update the Service Provider employee database 22 dynamically, whether at regular set intervals, or upon a change in the employer's 14 internal database.

Because not all employers 14 process their own payroll, it is also within the scope of this invention to incentivize payroll companies to utilize the services offered by the Service Provider 12. The Service Provider 12 may provide the print provider 18 with a volume and pricing grid based on the different types of available advertisements. The payroll processing company 14 can then act as a reseller of the services offered by the Service Provider 12. The permitted promotion is based on predetermined criteria received by the payroll processing company 14 from the Service Provider 12. In other words, the payroll processing company 14 can approach one of its customers (an employer 14), explain that they can continue to provide that employer 14 with the same service, but can reduce the employer's 14 cost, if the employer 14 signs up for the Service Provider's 12 program. This allows the payroll processing company 14 to set the price of forms created for participating employers 14 who use its services. Furthermore, it allows the payroll processing company 14 to negotiate directly with its customers. The payroll processing company 14 can make its own determination of the savings that will be passed on to its customers who participate in the program. When the payroll processing company 14 acts as a reseller, it explains to employers 14 how the program works, provides the employer 14 with the appropriate data collection forms, and then sends any completed data collection forms to the Service Provider 12. The Service Provider 12 then determines when an employer 14 can join the program based upon collection of all data, and adequate supply and demand.

Referring again to Fig. 7, the Service Provider 12 also selects print providers 18. The Service Provider 12 establishes relationships with print providers 18 based upon the Service Provider's 12 needs, which are in turn based on Service Provider's 12 existing relationship with employers 14 and advertiser 16. Just as the Service Provider 12 offers incentives to payroll processing companies, the same offer may be extended to print providers 18. The print providers 18 can also act like resellers in the same manner as the payroll processing companies to all employers 14 with whom they work directly.

In order to provide reduced costs business forms for employers 14 and payroll processing companies based on advertising, one needs advertisers 16. Advertisers 16 are pre-selected by various criteria including, but not limited to: size, location, products, industry served, and brand name. The pricing criteria for different advertisers 16 may be varied according to advertiser 16 needs. Pricing varies based up certain criteria, including: size of ad, color, number of impressions, target employers 14, target region, etc. The advertisers 16 are categorized by their company or product profiles and their target audience needs. Generally advertiser 16 needs are separated by demographics, psychographics or geographics. The data may be demographically categorized by age, gender, income level and job description, title or other criteria. The data may be psychographically categorized by products these consumers will buy, feelings these consumers have when buying a product, attitude consumers have when purchasing, etc. The data may also be categorized geographically by city, state, zip code, by Nielsen's DMA areas, which group cities into "Designated Market Areas", by the government's Metropolitan Service Areas (MSA) and other industry recognized geographic filtering means. Furthermore, data can be categorized by the government's Standard Industry Code (SIC) or industry classifications, the number of impressions requested, the time period allotted to an advertisement, color and size requirements, pricing requirements, and incentives.

Advertiser 16 data is updated in a manner similar to employee data. The Service Provider's advertiser database 24 containing advertisement information is updated based on the nature of individual advertisers 16. In other words, advertiser 16 data is updated upon the requests at the convenience of the advertiser 16. Preferably, the advertiser database 24 is linked to a web server 28. The process of updating the advertiser 16 information may comprise sending an electronic file such as a spreadsheet to the Service Provider 12 via e-mail. In another embodiment, the advertiser 16 may access a Service Provider advertiser database 24 linked to a web server 28 where the advertiser 16 can update its information or add new advertisement information. In this embodiment, the advertiser 16 can use any computer 26 to access a secure web server 28 having data managed by the Service Provider 12. In yet another embodiment, the advertiser's 16 internal database 26 may be configured to interact with the Service Provider's advertiser database 24 so that any change to the advertiser's 16 internal database dynamically updates the Service Provider's 12 database.

The Service Provider 12 uses the database information to match advertisers 16 with employers 14. Both advertiser 16 and employer 14 data are filtered using various criteria, depending on the individual advertiser's 16 needs. The data may also be queried in order to find an advertiser 16 for a particular employee set. The data can be filtered using any combination of the fields of data collected from both the advertisers 16 and employers 14. If a particular employer 14 is pre-selected, the database will match that employer 14 with potential advertisers 16, using the criteria in the advertiser 16 database and the information in the employer 14 database. The results of the query are then filtered again, if necessary, by using additional criteria such as the time sensitivity of the advertisement, the capability and schedule of the employer's 14 print provider 18, and the projected cost of the checks.

After the filtering is complete, the employer 14 will be notified of the list of potential advertisers 16 for the space available on its business forms. This notification may be a dynamically created e-mail or instant message update generated by the Service Provider's 12 database. If the employer 14 is adverse to any of the advertisers 16, those advertisers 16 can be removed from the list of potential advertisers 16. In one embodiment, the employer 14 may log in to the Service Provider's 12 secure web site and approve advertisers 16 through the web site. Upon approval of advertisers 16 from the employer 14, the approved advertisers 16 are notified that an available advertising space meets their pre-selected criteria. Again, this notification may be an e-mail notification. The e-mail notification may link advertisers 16 to a web page having an advertising grid created by the Service Provider's 12 database.

The advertising grid displays the available open advertisement space and the advertisers 16 submit bids for the open space. The grid will show that an advertisement matching given criteria is available. In one embodiment, the grid may provide the advertisers 16 with a hyperlink to another page on the Service Provider's 12 web site that contains more specific information about the open advertisement. In another embodiment, the database can be configured to send detailed information, including size, orientation, and color limitations to the advertiser 16 along with the e-mail notification that a space is available. Advertisers 16 may place their bids directly into a database using the Service Provider's 12 secure web site. The database may be configured to record and display all bids so that each competing advertiser 16 knows what its competition is willing to pay. The Service Provider 12 database can be configured to award the advertisement to the highest bidder, or to incorporate additional factors into the advertisement award, such as the amount of business brought in by a given advertiser 16, whether the advertiser 16 is also an employer 14, the amount of money a given advertiser 16 spends on advertisements with the Service Provider 12 annually, etc. When the Service Provider 12 accepts an advertisement, a reservation mark is placed in the advertising grid created by the Service Provider's 12 database so that all advertisers 16 can see that the space has been filled. The Service Provider 12 also notifies the chosen advertiser 16 that its bid has been accepted. Again, this notification may be via e-mail and the database may be configured to automate this process.

In one embodiment, print providers 18 also have access to the Service Provider's 12 secure Web site. The Service Provider's 12 database automatically generates for the print providers 18 a notification that an advertising space is available for an employee or payroll processor 14 with whom it is associated. This function is to prepare the print provider 18 for an upcoming print request from the Service Provider 12. Furthermore, the print providers 18 may be able to log into the dynamically created grid that the advertisers 16 use for bidding so that the print provider 18 may view the bidding process.

The advertiser 16 already knows the requirements of a given advertisement, so it can immediately send to the Service Provider 12 digital or printed proofs of the advertisement it wishes to run, along with an other specific information such as orientation, color, line screen, or file format information. The Service Provider 12 may or may not submit the advertisement to the employer 14 for approval prior to coordinating with the print provider 18 associated with the employer 14 to produce the desired advertisements. The print provider 18 then prepares and sends samples to the Service Provider 12, the employer 14 or payroll processor 14, and the advertiser 16 in either digital or printed form for evaluation prior to printing the checks.

Finally, checks are printed. All payments may be made directly to the Service Provider 12, who then distributes payments and rebates accordingly.

The present invention has been described with reference to preferred embodiments. Obviously, it will be appreciated by those skilled in the art that various additions, modifications, deletions and alterations will occur to others upon a reading and understanding of this specification, and may be made to such preferred embodiments without departing from the spirit and scope of the invention. Accordingly, it is intended that all such modifications and alterations be included within the scope of the invention as defined in the following claims.

Claims

1. A method for displaying advertisements on an employee's paycheck stub, comprising the steps of:
receiving employee data respectfully associated with a plurality of employees;
analyzing the employee data to categorize employees into a plurality of categories;
receiving from advertisers advertisement data respectfully associated with a plurality of advertisements;
associating advertisement data with a group of employees based on analysis of the employee data and the advertisement data;
selecting an advertisement associated with a group of employees; and
printing the selected advertisement on pay stubs of the group of employees.

2. The method of claim 1, wherein the pay stub is a direct deposit pay stub.

3. The method of claim 1, wherein the selected advertisement is printed on a reverse side of the employee's pay stub.

4. The method of claim 1, wherein the employee data comprises only non-private, non-confidential demographic information.

5. The method of claim 1, wherein the employee data further comprises the employee's income.

6. The method of claim 1, wherein the employee data further comprises psychographic information.

7. The method of claim 1, wherein the selection of an advertisement associated with a group of employees comprises a bidding process amongst the advertisers.

8. A system for displaying advertisements on an employee's paycheck stub, comprising:
means for receiving employee data respectively associated with a plurality of employees;
means for analyzing the employee data to categorize employees into a plurality of categories;
means for receiving from advertisers advertisement data respectfully associated with a plurality of advertisements;
means for associating advertisement data with a group of employees based on analysis of the employee data and the advertisement data;
means for selecting an advertisement associated with a group of employees; and
means for printing the selected advertisement on pay stubs of the group of employees.

9. The system of claim 8 wherein the means for receiving employee data is a secure web server comprising a database.

10. The system of claim 8 wherein the means for selecting an advertisement associated with a group of employees comprises a bidding processes amongst the advertisers.

11. The method of claim 9 wherein the advertisers submit bids via a secure web server.

12. A method of coordinating the display of advertisements to targeted groups of employees, comprising the steps of:
receiving employee data respectfully associated with employees of an employer;
receiving advertisement data respectfully associated with advertisements of advertisers;
choosing a set of employees from the received employee data;
matching the advertisement data with the employee data to create a set of matching advertisements for the chosen set of employees;
generating a list of advertisers associated with the matching advertisements;
notifying the employer of the chosen set of employees that matching advertisers have been located;
providing to the employer of the chosen set of employees the list of advertisers associated with the matching advertisements for the employer's approval;
receiving from employer a list of approved advertisers associated with the matching advertisements;
notifying the approved advertisers that target advertising is available for the chosen set of employees;
accepting bids from the approved advertisers for the right to display to the chosen set of employees the matching advertisements with which they are associated;
awarding to an approved advertiser the right to advertise to the chosen set of employees;
receiving from the awarded advertiser a matching advertisement;
submitting the received matching advertisement to the employer for approval; and
running the advertisement upon employer approval.

13. The method of claim 12 wherein the employer is notified via an electronic message that matching advertisers have been located.

14. The method of claim 13 wherein the electronic message contains a link to a web site and wherein the web site contains the list the list of matching advertisers.

15. The method of claim 12 wherein bids from the advertisers are accepted through a secure web server.

16. A method for offsetting the costs related to business form production comprising:
selling advertisement space on a business form;
receiving revenue from the sale of advertisement space on the business form; and
applying at least a portion of the received revenue to the costs related to the production of the business form.

17. The method of claim 16 wherein the costs related to the production of the business form are selected from the group consisting of: paper costs, printing costs, ink costs, processing costs, and combinations thereof.
